(19) United States
(12) Patent Application Publication
(10) Pub. No.: US 2005/0108426 A1
(43) Pub. Date: May 19, 2005

(54) Identifying computer messages that should be revised

(76) Inventor: Udo Klein, Maximiliansau (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/770,631

(22) Filed: Feb. 3, 2004

Related U.S. Application Data
(63) Continuation-in-part of application No. 10/698,958, filed on Oct. 31, 2003.

(51) Int. Cl. G06F 15/16

(52) U.S. Cl. 709/238

(57) ABSTRACT

Gathering information about a user message in a computer system may include detecting a user message identifier that a program uses in presenting a user message in a computer system where the program is being executed. The detected user message identifier may be used in storing information about the presented user message in a log that is accessible to a user of the computer system. The stored information may include how many messages have been generated, to which user names the message(s) were issued, a program or subroutine that triggered the message, and a status of a call stack when the message was issued. The message identifier(s) may be detected in a message handler, the kernel, or in another unit of the computer system. The gathered information may be automatically analyzed to determine whether the user message is unsuitable for end users.

This application claims priority as a continuation-in-part application of pending U.S. patent application Ser. No. 10/698,958, filed Oct. 31, 2003 and entitled “GATHERING MESSAGE INFORMATION,” the entire contents of which are incorporated herein by reference.

### TECHNICAL FIELD

This description relates to identifying, where many standard user messages such as error messages are generated in a computer system, those of the generated messages that should be revised to make them more understandable to a user.

### BACKGROUND

Most software applications include messages that can be presented to a user at certain times. User messages are often in form of a dialog box displayed on a computer screen to inform the user of something or to elicit input or information from the user. However, a particular system may include some user messages that are not very helpful to the user. Their language may be poorly drafted or out of date, or they may have been intended mainly for the benefit of developers. Larger applications can include a great number of user messages and it may be impracticable to overview what messages are actually generated by the system and when they are generated. Moreover, this problem may remain even if there is a so called “where used” list for the user messages in a particular application, because such lists typically specify which parts of the software code that can trigger a particular message, but have no information on whether or how often the code is actually executed. In addition, these lists relate to messages that are specified by the software code and do not cover dynamic messages that are not coded.

There exists coverage analyzers for software code that may track which portion(s) of the code the system actually executes. However, such analyzers do not track which message(s) the code generates or relevant information about the generated messages. The execution of a particular piece of software code may furthermore not be an absolute indicator that a message was generated, because such generation may depend on the presence or absence of other conditions that cannot be determined from the code. Code coverage analyzers also may not provide information on system status.

### SUMMARY

The invention relates to analyzing message information to identify user messages that are unsuitable for being presented to end users. In a first general aspect, a method comprises accessing a message log comprising information about a plurality of user messages that have been presented in a computer system during a period of time. The information includes contents of the plurality of user messages. An automated rule is applied to the contents of the plurality of user messages in the message log to determine whether any of the plurality of user messages is unsuitable for being presented to end users of the computer system. An output is provided that identifies any of the plurality of user messages for which the automated rule is met.

In selected embodiments, the rule is applied to determine any or all of the following: whether the content is consistent with a system language for the message; whether the content includes a specific undesirable word; whether the message is primarily intended for developers of the computer system; and whether the message includes only dynamic contents.

In a second general aspect, a computer system includes a memory having stored therein a message log that comprises information about a plurality of user messages that have been presented during a period of time. The information includes contents of the plurality of user messages. The computer system further includes a program product including executable instructions that, when executed by a processor of the computer system, cause the computer system to apply a rule to the contents of the plurality of user messages in the message log to determine whether any of the plurality of user messages is unsuitable for being presented to end users, and that further cause the computer system to provide an output identifying any of the plurality of user messages for which the rule is met.

In selected embodiments, the message log is imported into the computer system to have a rule applied to the message contents. In such embodiments, the message log relates to messages that were presented in a separate computer system.

Advantages of the systems and techniques described herein may include one or more of the following. A computer system can be made more user-friendly. An automated review of user messages can be performed to determine if any of them needs to be revised. Unintelligible or meaningless user messages can be conveniently tracked down for revision. A decision whether to revise any of several deficient user messages in a computer system can be aided by knowing how frequently each of them is generated.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a computer system capable of gathering message information;

FIGS. 2 and 3 are exemplary logs generated by the system shown in FIG. 1;

FIG. 4 is a flow chart of a method of gathering message information;

FIG. 5 is an exemplary result of analyzing a message log;

FIG. 6 is a block diagram of a computer system capable of analyzing message information;

FIG. 7 is a flow chart of a method of analyzing message information; and

FIG. 8 is a block diagram of a computer system.

Like reference numerals in the various drawings indicate like elements.

### DETAILED DESCRIPTION

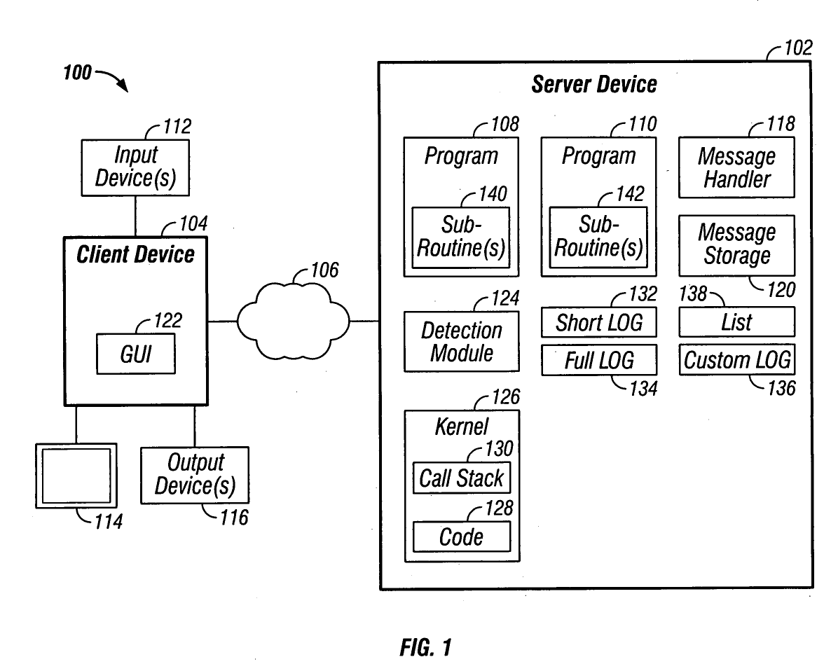

FIG. 1 schematically shows a computer system 100 including a server device 102 and a client device 104 connected by a network 106. A user of the client device 104 can interact with one or more programs 108 and 110 using input device(s) 112, a display device 114 and output device(s) 116 operably connected to the client device 104. Particularly, the system 100 is capable of gathering information about one or more messages presented to the user as will be described below.

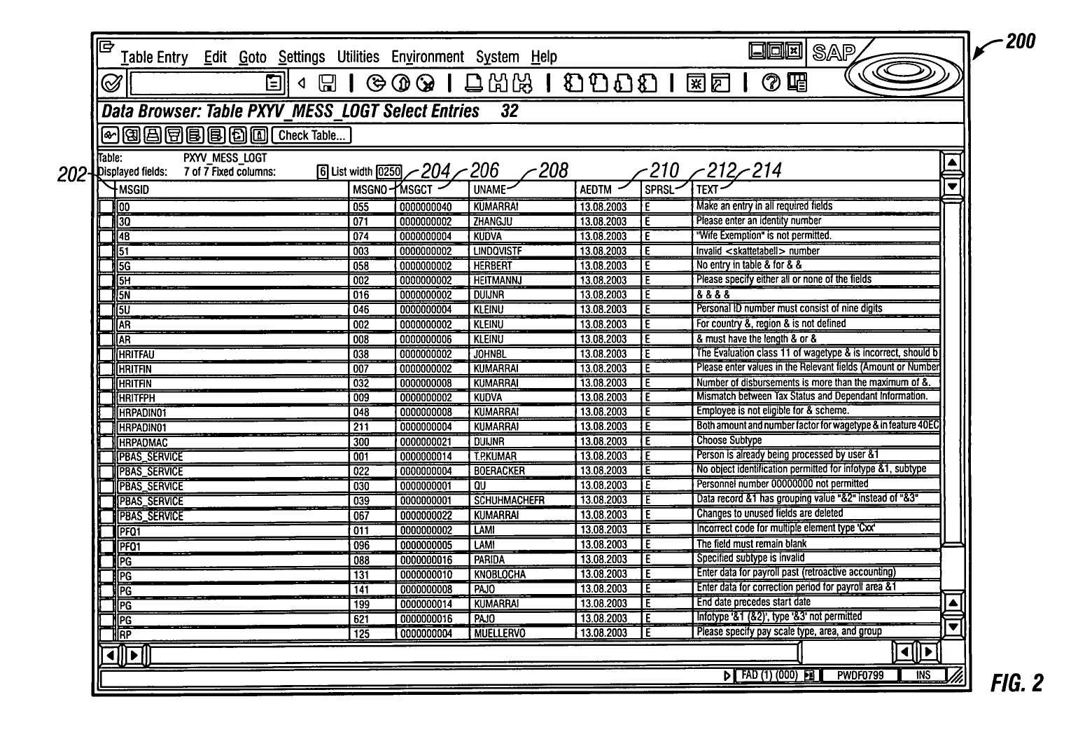

The following is an example of how a user message may be presented while the program 108 is being executed in system 100. The user makes an input using the input device(s) 112, such as a keyboard or a pointing device. The input is transmitted to the server device 102, where it is received and processed in the execution of program 108. In this example, the user input triggers the program 108 to issue a user message, perhaps because the input was of an improper format or because the program 108 is configured to ask the user for confirmation before carrying out certain operations. The user message that is to be presented may be handled through one or more events in a message handler 118 on the server device 102. Typically, a message identifier 204 (see FIG. 2) identifies the message. The message identifier may be a number, a character string, or any other information that serves to identify the message. Using the message identifier 204, a text 214 (see FIG. 2) of the message (assuming it is a written message) can be retrieved from a message storage 120 on the server device 102. The server device 102 transmits the user message to the client device 104 where it is to be presented to the user. A visual message can be presented on the display device 114 using a graphical user interface (GUI) 122. Other types of user messages can be presented to the user through output device(s) 116, such as a speaker.

More than one person can use the program(s) 108 at the same time if there is more than one client device connected to the server device 102. Various user messages may then be presented to the different users depending on how they interact with the program(s).

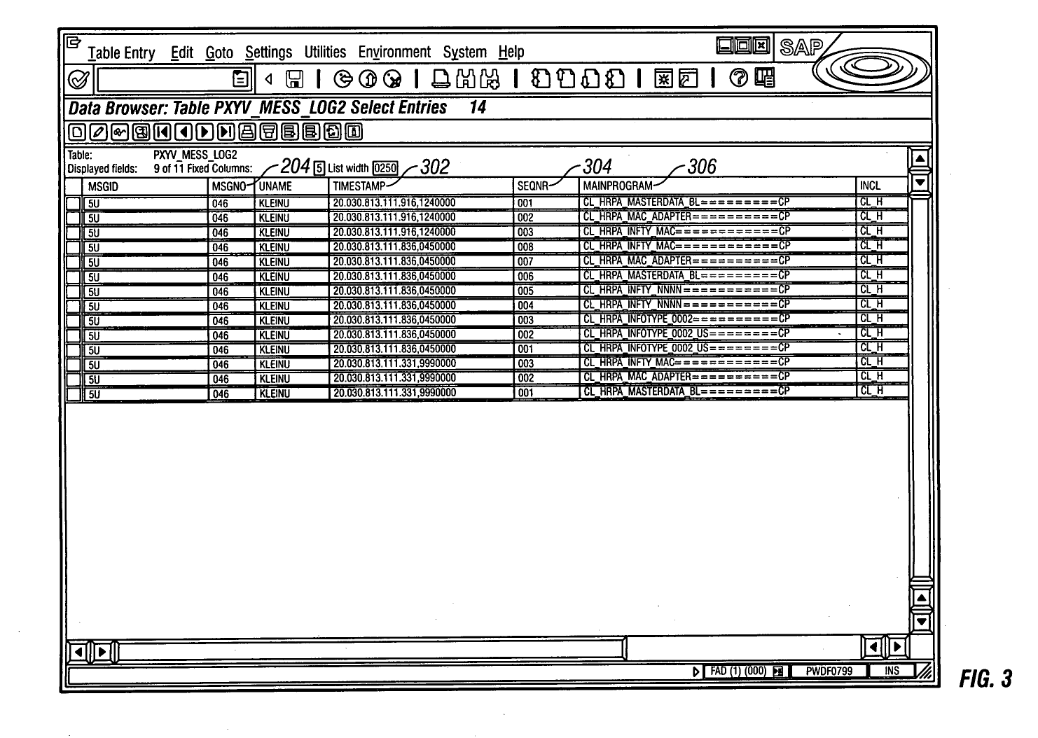

The server device 102 includes a detection module 124 that detects 402 (see FIG. 4) a user message identifier relating to the presented message and stores 404 (see FIG. 4) information about the message. If the detection module 124 is used to monitor user messages for a period of time, it can gather information about a relatively large number of messages. The gathered user message information can optionally be used in analyzing the operation of the server device 102, and particularly of the program 108 or 110, which triggered the message. The information may provide insight on whether any of the messages that the program(s) can generate need(s) revision. For example, it may be decided to modify a specific user-unfriendly message because it appears very often but to do nothing about another flawed message because it is almost never generated.

The detection module 124 may monitor the message handler 118 to detect the user message identifier(s). Particularly, where the presentation of a user message is associated with one or more events in the message handler 118 the detection module 124 may monitor events in the message handler that relate to presentation of user messages. Preferably, the detection module 124 does not affect the operation of the message handler 118 and the programs 108, 110; that is, these components should not “notice” the detection.

In other implementations, for example those where no message handler 118 exists, the detection may take place in another unit of the computer system 100 where user message identifiers 204—preferably a majority of them—can be detected. One example involves monitoring information in a kernel 126 of the server device 102. Code 128 may be introduced in the kernel 126 to monitor messaging information there. Such messaging information may include message statements that relate to messages generated by one or more of the programs 108 and 110. Particularly, the kernel 126 may include a call stack 130 that keeps track of calls made in the system 100, such as calls made by one or more subroutines 140, 142 in programs 108, 110. The detection module 124 may store information about presented user messages retrieved from the call stack 130.

The detection module 124 may store information about presented user messages in a log that is accessible to a user of the server device 102. In this example, the detection module 124 can store message information in any of logs 132, 134 and 136 on the server device 102. Panel 200 in FIG. 2 is an example of how the system 100 can display a custom log 136 and panel 300 in FIG. 3 is an example of how the system 100 can display a full log 134. For example, the logs may be displayed on client device 104 using display device 114 or on another device connected to the server device 102.

One difference between the logs in this example is how much information about each message is stored. A user may define the custom log 136 such that the detection module stores message information other than what is stored in the short and full logs, optionally together with any or all of their types of information. Different levels of information granularity in the logs may facilitate different levels of diagnostics on the generation of user messages.

The detection module 124 may access a list 138 for specific instructions. The list 138 may specify for which user messages the detection module 124 should store message information. Accordingly, based on information in the list 138 the detection module 124 may ignore certain user messages. As another example, the list 138 may specify what information about a particular message is to be stored. The list may do this by specifying in which of the logs 132, 134 and 136 to store information about the message(s). One of the logs, such as short log 134, may be a default log for storing information about any user message for which the list 138 does not specify a different log.

The panel 200 in FIG. 2 contains respective columns for user message areas 202, message identifiers 204 (here, a unique number identifying the message), numbers 206 of generated messages for each identifier, user names 208 in the system 100 to whom the user messages were presented, dates 210 when the messages were (most recently) presented, language keys 212, and texts 214 of the user messages. In this example, message information was gathered while several user names 208 were using the system 100.

The user message areas 202 and message identifiers 204 are labeled “MSGID” and “MSGNO”, respectively, in this exemplary embodiment. For reasons not important to this description, the programs 108, 110 may use two or more items collectively as a name for the user message, such as the message area 202 and message identifier 204 in this implementation. What the detection module 124 detects, on the other hand, may be anything that uniquely identifies a presented message; in this example, the message identifiers 204.

The language keys 212 indicate the system language in which the messages were issued, here English (“E”). Thus, the gathered message information can for example be used to determine whether any of the language keys 212 is inconsistent with its corresponding text 214.

Any of the information in panel 200 (and hence in any of the logs 132, 134 and 136) may be continually updated. For example, if the detection module 124 detects that an additional message is being presented, it may find the entry for that message in the log (optionally by first referring to list 138), and increase the number 206 for that message by one. If the message is not listed in the log, the message may be added as a new row and its information be entered accordingly. The short log 134 may include selected portions of this information for the messages registered in that log, such as everything except the language keys 212 and text 214 columns.

The panel 300 can be displayed based on information in the full log 134, which may store more detailed information regarding messages than logs 132, 136. In this example, only messages having the same message identifier 204 are listed, and they are distinguished by their different time stamps 302 or sequence numbers 304. For messages having identical time stamps 302, the sequence numbers 304 indicate an order in which the messages were generated. The panel 300 indicates for each message which program 306 caused the message to be presented. As an example, the information in panel 300 may have been obtained from the call stack 130.

In other implementations, any or all of the logs 132, 134 and 136 may also or instead list other information. Such information may include an event that triggered the user message, information on where in the computer system 100 the message was triggered, such as which subroutine(s) 140 or 142 triggered the message, or a status of a system flag in the system 100 when the message was generated.

FIG. 4 is a flow chart of a method 400 for gathering message information. Preferably, method 400 is executed by a server device. For example, a computer program product can include instructions that cause a processor of the server device to execute the steps of method 400. Method 400 for gathering message information includes the following steps:

Detecting 402 a user message identifier 204 that a program 108, 110 uses in presenting a user message in a computer system 100 where the program 108, 110 is being executed.

Using the detected user message identifier 204 in storing 404 information 200, 300 about the presented user message in a log 132, 134, 136 that is accessible to a user of the computer system 100.

Gathering the various types of message information described above may facilitate useful analyses of the message generation in system 100. For example, the number 206 of generated messages for each type indicates how often messages are generated, which in turn may aid a decision on whether the message needs revision. Other information, such as the program or subroutine that caused the message to be generated, may aid a revision of a message and the understanding of unexpected behavior in the system 100. As an example, information from the call stack 130 may allow tracing of the calls made by any of programs 108, 110 or subroutines 140, 142 that resulted in a user message being generated.

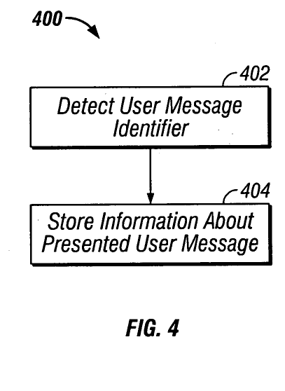

It may be advantageous to perform automatic analysis of the gathered message information. An automatic analysis can identify the user message(s) that should be revised. FIG. 5 shows an exemplary panel 500 that presents results of an automatic message analysis. As will be described below, the panel 500 is generated by applying rules to a message log, such as any of the message logs 132, 134 or 136. The rules may be configured so that they can identify characteristics that make the user messages unsuitable for being presented to end users. For example, a message may be unsuitable because, due to mistake, it is written in a language other than the language that the system specifies for it. As another example, a message may include overly technical language that makes it unsuitable for end users. Here, panel 500 includes only those messages that were deemed unsuitable when one or more rules were applied to them. That is, panel 500 does not list any analyzed messages that have no problems.

The messages identified in the analysis are presented on separate rows of the panel 500. A message identifier column 510, similar to the message identifier column 204 described above with regard to FIGS. 2 and 3, lists the identifier for each identified message. A text column 520 is similar to the text column 214 described above and includes the respective contents of each identified message.

A result column 530 indicates any problem(s) identified in the automatic analysis. When several rules are used, a number of different problems can be identified. Also, more than one problem can be listed for a single message. In this example, field 531 for the message having number 223 states “Wrong language,” which indicates that the English text of this message (“Choose subtype”) should have been written in a different language. Typically, the system assigns a system language for each message that is generated, as described above with regard to the language keys 212 in panel 200. It may happen that the generated message is written in a different language than the system language that is specified for it. For example, a bilingual developer who intends to write a message in one language may inadvertently write it in another language. The result of this mistake may be that when the system generates a message that is supposedly written in English (because that is the system language set for the message), the message that is actually presented to the user is written in German. It will be described below how such a discrepancy can be detected.

The next message in panel 500 has number 249 and has the result “Undesirable word” listed in column 530. The text contents of messages may be scanned during the automatic analysis to determine whether one or more undesirable words occur in them, as will be described below. Such analysis is useful in identifying messages that may be outdated or otherwise need revision. For example, one of the words “Subroutine” and “configured” appearing in the text column 520 may have been targeted, perhaps in an attempt to revise the use of this terminology in the system.

The next message in panel 500 has number 361 and its result in column 530 states “Content empty”. As seen in text column 520, this message has no text. An “empty” message such as this may have been initially created by mistake, or a developer may have created the message for a limited testing purpose and inadvertently left it in the system. Regardless of the reason why it exists, an empty message is unsuitable for being presented to an end user.

The last message in the panel 500 has number 419 and has the term “Technical” listed in the result column 530. The message text—“Error F125”—is technically accurate but may be of little value to a typical end user because it presumes that the user knows the significance of this error code. This type of message may be among those that are created in a development phase and are not intended for the final version of the system. Accordingly, the automated message analysis provides that such messages can be identified.

The panel 500 provides a link column 540 by which a user can conveniently access any of the listed messages for editing. That is, by activating any of the “Edit” links in column 540, the text of the respective message can be accessed. For example, the “Edit” links may identify the individual records for the messages in the message storage 120 described above with regard to FIG. 1.

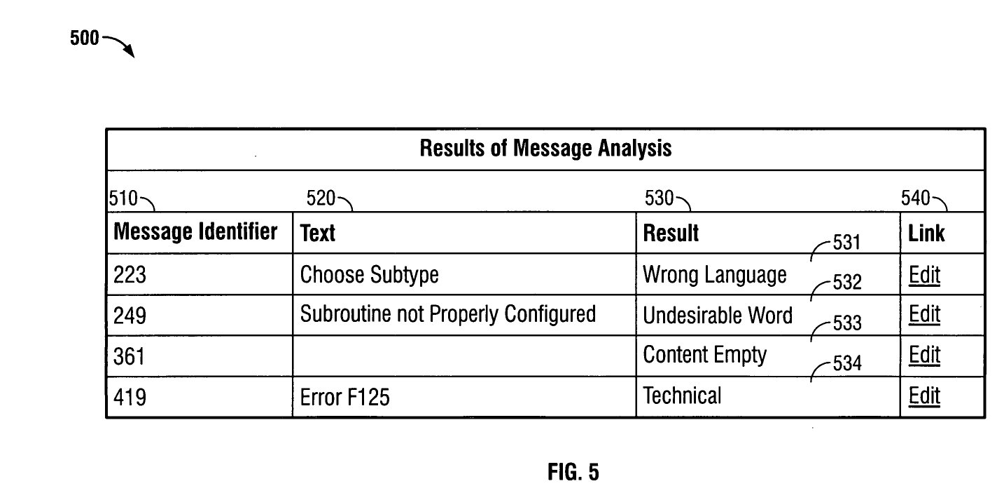

FIG. 6 shows an exemplary computer system 600 that is capable of automatically analyzing message contents. Based on such an analysis, it can be decided whether one or more messages are unsuitable for being presented to users. If so, appropriate revision(s) can be made.

The system 600 includes a processing unit 601. The processing unit 601 includes, in a data storage 605, one or more message log(s) 610 that can be analyzed. For example, the log(s) 610 may include any of the message logs 132, 134 and 136 described above. The message log(s) 610 may relate to messages that were presented in the system 600 or in another system. That is, the message log 610 may be analyzed in the same system where its information was gathered. As another example, the message log 610 may be imported to the system 600 for being analyzed after being compiled in a separate computer system (such as the system 100).

Currently located in a program memory 615 of the processing unit 601 is a message analysis program (MAP) 620. The MAP 620 includes instructions that, when executed by a processor, cause the computer system 600 to analyze the message log(s) 610 to determine whether any of the messages are unsuitable for end users, as will be described below. For example, the MAP 620 may be a program product stored in the system 600.

To analyze the messages, the system 600 accesses the log 610 and selectively applies one or more rule(s) 630 to the message contents. The rule(s) 630 should be formulated to identify messages whose contents render them unsuitable for end users, as will be described in a few examples below. A user interacts with the system 600 using input/output device 640, which may for example include a keyboard, pointing device and a display device operably connected to the processing unit 601. For example, the user initiates the message analysis with an input from the keyboard or pointing device. The system 600 displays the results of the message analysis (such as panel 500 shown in FIG. 5) on display device 640.

As an example, the rule(s) 630 may target messages written in the wrong language. With reference to FIG. 2 above, a message log may include the message text 214 and a language key 212 that specifies a system language for each message. Per the instructions in MAP 620, the system 600 may determine, for each message in the message log 610, if the key 212 and the text 214 are consistent. The system 600 may access an electronic dictionary 650 for the system language. The system retrieves one or more words from the text 214 and compares the word(s) with the dictionary 650 to see if there is a match.

However, some user messages include words that have a meaning in more than one language. It follows that such words might have matching entries in dictionaries for more than one system language. In some embodiments, therefore, the dictionary 650 may be a pre-processed dictionary for the system language, wherein any multiple-language word in the dictionary is not taken into account in the comparison. The task of identifying multiple-language words in any dictionary can be limited to address only the system language(s) used in the system and any additional language known to be spoken by any developer that creates messages. In other embodiments, any suitable software-implemented language recognition method may be applied to the message contents instead of making a comparison with the dictionary 650.

The applied rule is met if the dictionary 650 does not contain the retrieved word(s). If the rule is met for any message(s) in the log 610, the system outputs the panel 500 that identifies the particular message(s) for which the rule was met. The dictionary 660, of which there may be more than one if there are several system languages, may be stored locally or may be accessed remotely, such as an online dictionary.

As another example, the rule(s) 630 may target messages that include one or more undesirable words. This may be useful if the automatic message analysis is being performed as part of an effort to replace outdated words with current terminology. The system 600 may access a word list 660 and compare it with the text 214. The list 660 may include outdated words that are believed to occur in the user messages. Similarly, the list 660 may include words believed to occur in the user messages that users typically do not understand. Thus, the word list 660 may include any word that is sought to be eliminated from the user messages. The rule is met if there is a match between the message contents and the list 660. If the rule is met for any message(s) in the log 610, the system 600 outputs the panel 500 that identifies the message(s).

As yet another example, some messages may be intended primarily for developers and not for end users. Such messages may be identified by the use of specific expert terminology, special error codes, or other characteristics. For example, including the undesirable word(s) in the list 660 may identify these messages. As another example, it may be possible to identify such messages based on the format of their text contents, such as the word “error” followed only by a number or other identifier, as was the case with the message number 419 described above. The rule is met for any message that qualifies as being a “developers-only” message. Any such message(s) are identified in the panel 500 that is output by the system.

As a few final examples, the rule(s) 630 may target messages that have no content; that is, messages whose text 214 does not contain any word, or messages that have only dynamic content and no static content. The difference between dynamic and static message content is that the former is determined only at runtime. A message that includes dynamic content will therefore include one or more placeholders while it is stored in message storage 120. At runtime, user-understandable content will be substituted for the placeholder(s). Messages having entirely dynamic contents are much more difficult to translate, especially with an automated translation method, and it may therefore be desirable to identify these messages so they can be revised. Thus, the rule is met for any message that has no content, or whose content is entirely dynamic, and the system outputs the panel 500 that identifies the message(s). In a similar way, other rules that identify unsuitable messages based on their content may be used.

The user may wish to edit the message(s) that have been identified in the message analysis. For this purpose, the system 600 includes link(s) 670 to the contents of each message that is identified in the panel 500. For example, the link(s) 670 may provide the user access to the message text(s) in message storage 120, which was described above with reference to FIG. 1. The link(s) 670 may be provided to the user in link column 540 shown in FIG. 5.

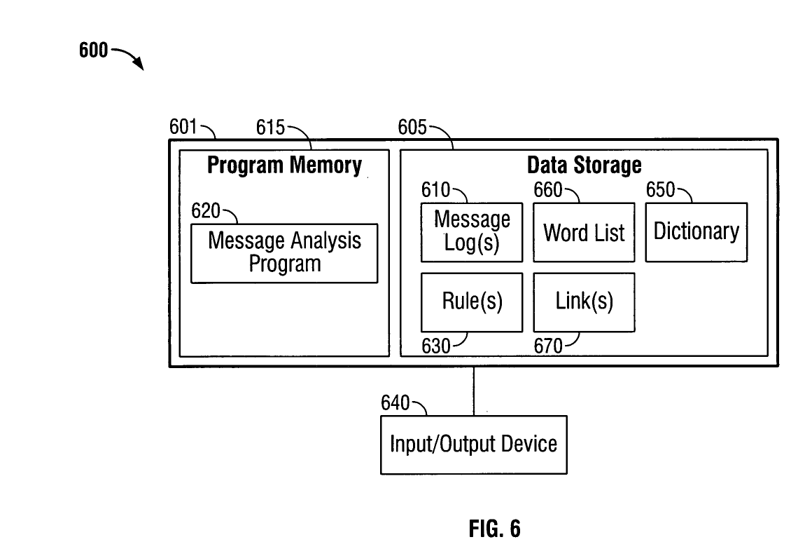

FIG. 7 is a flow chart of a method 700 for identifying user messages that should be revised. Preferably, method 700 is executed by the system 600. For example, a computer program product can include instructions that cause a processor of the system 600 to execute the steps of method 700. Method 700 includes the following steps:

In optional step 710, receiving input for applying the rule(s) 630. Step 710 may include the message log(s) 610 or the word list 660 being imported into the system.

Accessing, in step 720, the message log 610 that comprises information about user messages that have been presented in a computer system (100, 600) during a period of time. The information includes contents (text 214) of the user messages.

Applying, in step 730, a rule 630 to the contents of the user messages in the message log 610 to determine whether any of the plurality of user messages is unsuitable for being presented to end users of the computer system (100, 600).

Providing an output in step 740 that identifies any of the plurality of user messages for which the rule is met.

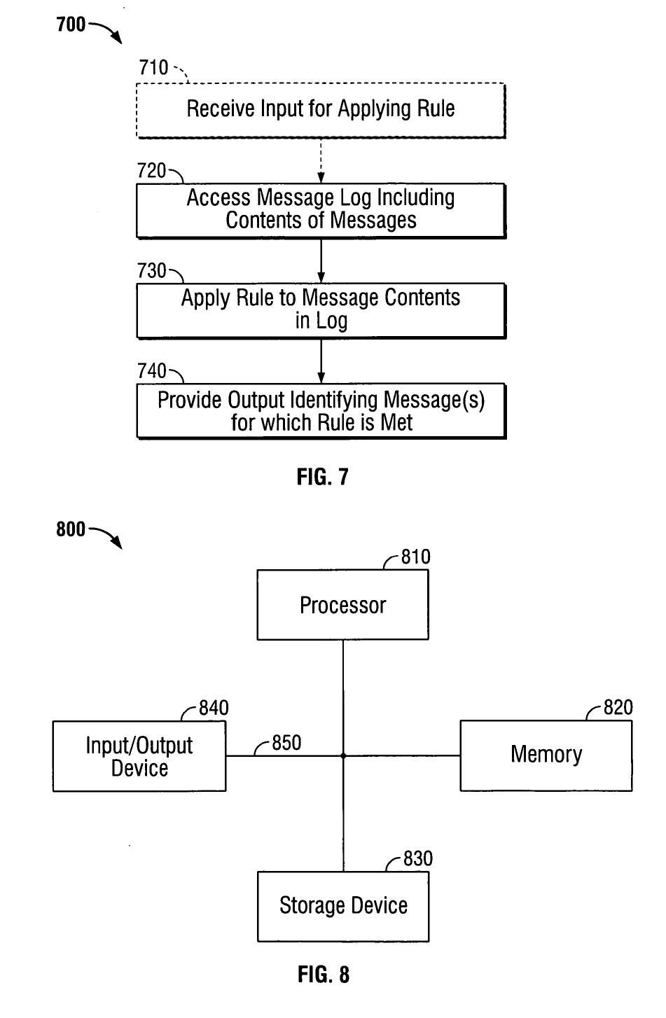

FIG. 8 is a block diagram of a computer system 800 that can be used in the operations described above, according to one embodiment. The system 800 includes a processor 810, a memory 820, a storage device 830 and an input/output device 840. Each of the components 810, 820, 830 and 840 are interconnected using a system bus 850. The processor 810 is capable of processing instructions for execution within the system 800. In one embodiment, the processor 810 is a single-threaded processor. In another embodiment, the processor 810 is a multi-threaded processor. The processor 810 is capable of processing instructions stored in the memory 820 or on the storage device 830 to display graphical information for a user interface on the input/output device 840.

The memory 820 stores information within the system 800. In one embodiment, the memory 820 is a computer-readable medium. In one embodiment, the memory 820 is a volatile memory unit. In another embodiment, the memory 820 is a non-volatile memory unit.

The storage device 830 is capable of providing mass storage for the system 800. In one embodiment, the storage device 830 is a computer-readable medium. In various different embodiments, the storage device 830 may be a floppy disk device, a hard disk device, an optical disk device, or a tape device.

The input/output device 840 provides input/output operations for the system 800. In one embodiment, the input/output device 840 includes a keyboard and/or pointing device. In one embodiment, the input/output device 840 includes a display unit for displaying graphical user interfaces as discussed above.

For example, the server device 102 discussed with reference to FIG. 1 above may include the processor 810 executing one or more software programs stored in one of memory 820 and storage device 830. In addition, the client device 104 shown in FIG. 1 may include separate instances of processor 810, memory 820 and storage device 830. Lastly, the processing unit 601 shown in FIG. 6 may include a separate instance of processor 810.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of identifying any of a plurality of user messages in a computer system that is unsuitable for being presented to end users, the method comprising:
accessing a message log comprising information about a plurality of user messages that have been presented in a computer system during a period of time, the information including contents of the plurality of user messages;
applying an automated rule to the contents of the plurality of user messages in the message log to determine whether any of the plurality of user messages is unsuitable for being presented to end users of the computer system; and
providing an output identifying any of the plurality of user messages for which the automated rule is met.

2. The method of claim 1, wherein the information further includes keys associated with the user messages, each key identifying a system language for the user message with which it is associated, and wherein applying the automated rule comprises determining, for each of the user messages, whether the content is consistent with the key.

3. The method of claim 2, wherein applying the automated rule comprises comparing, for each of the user messages, at least one word from the content with an electronic dictionary for the system language identified by the key that is associated with the user message.

4. The method of claim 1, wherein applying the automated rule comprises determining, for each of the user messages, whether the content includes a specific undesirable word.

5. The method of claim 1, wherein applying the automated rule comprises determining, for each of the user messages, whether the user message is primarily intended to be presented to developers of the computer system.

6. The method of claim 1, wherein applying the automated rule comprises determining, for each of the user messages, whether the user message includes only dynamic content.

7. The method of claim 1, wherein providing the output further comprises displaying a link by which the content of any identified user message can be accessed for editing.

8. A computer program product containing executable instructions that when executed cause a processor to perform operations comprising:
access a message log comprising information about a plurality of user messages that have been presented in a computer system during a period of time, the information including contents of the plurality of user messages;
apply an automated rule to the contents of the plurality of user messages in the message log to determine whether any of the plurality of user messages is unsuitable for being presented to end users of the computer system; and
provide an output identifying any of the plurality of user messages for which the automated rule is met.

9. The computer program product of claim 8, wherein the operations further comprise:
receive the automated rule that is to be applied, wherein a plurality of automated rules can be received and selectively applied to the contents of the user messages.

10. The computer program product of claim 8, wherein the operations further comprise:
receive a list of at least one undesirable word, wherein applying the automated rule comprises determining whether the content includes the at least one undesirable word.

11. A computer system comprising:
a memory having stored therein a message log that comprises information about a plurality of user messages that have been presented during a period of time, the information including contents of the plurality of user messages; and
a program product including executable instructions that, when executed by a processor of the computer system, cause the computer system to apply a rule to the contents of the plurality of user messages in the message log to determine whether any of the plurality of user messages is unsuitable for being presented to end users, and that further cause the computer system to provide an output identifying any of the plurality of user messages for which the rule is met.

12. The computer system of claim 11, wherein the information further includes keys associated with the user messages, each key identifying a system language for the user message with which it is associated, and wherein the rule is applied to determine, for each of the user messages, whether the content is consistent with the key.

13. The computer system of claim 12, wherein the computer system compares, for each of the user messages, at least one word retrieved from the content with an electronic dictionary for the system language identified by the key that is associated with the user message.

14. The computer system of claim 11, further comprising a list stored in the memory, the list identifying at least one undesirable word, wherein the rule is applied to determine, for each of the user messages, whether the content includes the at least one undesirable word.

15. The computer system of claim 11, wherein the output that the computer system can provide further comprises a displayable link by which the content of any identified user message can be accessed for editing.

16. The computer system of claim 11, wherein the message log is imported into the computer system and wherein the user messages to which the message log relates were presented in a separate computer system.
